(19) United States
(12) Patent Application Publication
(10) Pub. No.: US 2025/0309308 A1
(43) Pub. Date: Oct. 2, 2025

(54) FUEL CELL STACK

(71) Applicant: Honda Motor Co., Ltd., Tokyo (JP)

(72) Inventors: Masakazu Fukamachi, Tokyo (JP); Tatsuya Hasegawa, Tokyo (JP); Satoru Uchiumi, Tokyo (JP)

(21) Appl. No.: 19/062,027

(22) Filed: Feb. 25, 2025

(30) Foreign Application Priority Data
Mar. 29, 2024 (JP) 2024-056085

(51) Int. Cl. H01M 8/2404; H01M 8/0247; H01M 8/0273; H01M 8/2418; H01M 8/2475

(52) U.S. Cl. CPC H01M 8/2404; H01M 8/0247; H01M 8/0273; H01M 8/2418; H01M 8/2475

(57) ABSTRACT

A fuel cell stack including a cell stacked body having power generation cells, a guide part protruding from inner wall of a case toward the cell stacked body, a positioning portion provided on an edge portion of the power generation cell to position the power generation cell relative to the case. The positioning portion includes first and second protruding portions from first and second edge portions of the power generation cell, the guide part includes a first guide part provided on one side in a first direction of the first protruding portion and a second guide part on the other side in the first direction of the second protruding portion, and the first and second guide parts include a first and second abutting surface abutting a first and second end surface of the first and second protruding portions.

### CROSS-REFERENCE TO RELATED APPLICATION

This application is based upon and claims the benefit of priority from Japanese Patent Application No. 2024-056085 filed on Mar. 29, 2024, the content of which is incorporated herein by reference.

### BACKGROUND OF THE INVENTION

### Field of the Invention

This invention relates to a fuel cell stack including a stacked body of a plurality of power generation cells.

### Description of the Related Art

In recent years, technological developments have been made on a fuel cell that contribute to energy efficiency in order to ensure access to energy that is affordable, reliable, sustainable and advanced by more people. As a conventional technology related to a fuel cell stack used in this type of fuel cell, it is known to erect guide bars on a mounting table and engage recess portions provided on the edges of power generation cells with the guide bars while stacking the power generation cells on the mounting table to form a stacked body. Such a technology is described, for example, in Japanese Unexamined Patent Publication No. 2022-132847 (JP 2022-132847 A). In the stacked body described in JP 2022-132847 A, a coating layer is provided on the surface of the guide bar to reduce frictional resistance between the power generation cells and the guide bar during stacking of the power generation cells.

However, providing a coating layer on the surface of the guide bar as in the stacked body described in JP 2022-132847 A increases the assembly process of the fuel cell stack, leading to higher costs.

### SUMMARY OF THE INVENTION

An aspect of the present invention is a fuel cell stack including: a power generation cell including a unitized electrode assembly having an electrolyte membrane and an electrode, and a separator; a cell stacked body including a plurality of the power generation cells stacked in a predetermined direction; a case surrounding the cell stacked body; a guide part provided on an inner wall of the case and configured to protrude toward the cell stacked body and extend in the predetermined direction; and a positioning portion provided on an edge portion of the power generation cell, corresponding to the guide part, to position the power generation cell relative to the case. The edge portion of the power generation cell includes a first edge portion and a second edge portion on an opposite side of the first edge portion, the positioning portion includes a first protruding portion protruding from the first edge portion toward the inner wall and a second protruding portion protruding from the second edge portion toward the inner wall, the first protruding portion and the second protruding portion includes a first end surface and a second end surface extending in a substantially perpendicularly to the first edge portion and the second edge portion, respectively, when mutually opposite sides in a plan view perpendicular to the predetermined direction are defined as a first side and a second side, the first end surface is located on the first side and the second end surface is located on the second side, and the guide part includes a first guide part having a first abutting surface provided so as to face the first end surface to abut the first end surface, and a second guide part having a second abutting surface provided so as to face the second end surface to abut the second end surface.

### BRIEF DESCRIPTION OF THE DRAWINGS

The objects, features, and advantages of the present invention will become clearer from the following description of embodiments in relation to the attached drawings, in which:

FIG. 1 is a perspective view schematically showing an overall configuration of a fuel cell stack according to an embodiment of the present invention;

FIG. 2 is a cross-sectional view of a main part of a cell stacked body included in the fuel cell stack of FIG. 1;

FIG. 3 is a cross-sectional view of a main part of FIG. 1 showing a configuration of a unitized electrode assembly;

FIG. 4A is a cross-sectional view of a main part of FIG. 1 showing a configuration of a first separator;

FIG. 4B is a cross-sectional view of a main part of FIG. 1 showing a configuration of a second separator;

FIG. 5A is a diagram illustrating an example of a procedure of an assembly method for the fuel cell stack according to the embodiment of the present invention;

FIG. 5B is a diagram illustrating an example of a procedure following the procedure in FIG. 5A;

FIG. 5C is a diagram illustrating an example of a procedure following the procedure in FIG. 5B;

FIG. 5D is a diagram illustrating an example of a procedure following the procedure in FIG. 5C; and

FIG. 5E is a diagram illustrating an example of a procedure following the procedure in FIG. 5D.

### DETAILED DESCRIPTION OF THE INVENTION

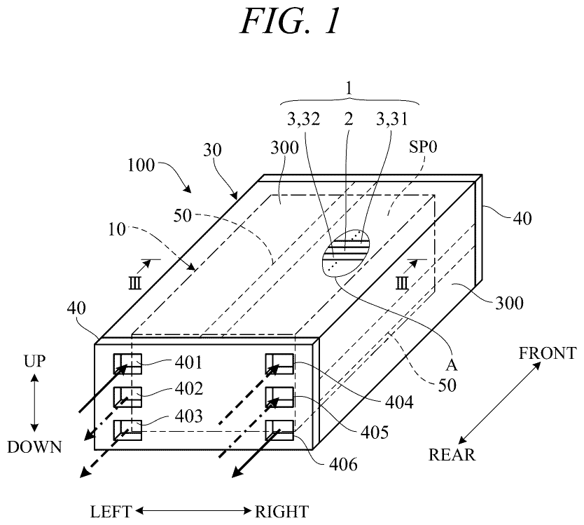

Hereinafter, an embodiment of the present invention will be described with reference to FIGS. 1 to 5E. A fuel cell stack according to an embodiment of the present invention is a main component of a fuel cell. The fuel cell is mounted on, for example, a vehicle and can generate electric power for driving the vehicle. The fuel cell can be mounted on various industrial machines in addition to a moving body other than a vehicle such as an aircraft or a boat, a robot, and the like.

First, an overall configuration of the fuel cell stack will be schematically described. FIG. 1 is a perspective view schematically showing an overall configuration of a fuel cell stack 100 according to the embodiment of the present invention. Hereinafter, for the sake of convenience, three-axis directions orthogonal to each other as illustrated in the drawing are defined as a front-rear direction, a left-right direction, and an up-down direction, and a configuration of each unit will be described according to such definitions. These directions may be different from a front-rear direction, a left-right direction, and an up-down direction of the vehicle. For example, the front-rear direction of FIG. 1 may be the front-rear direction, the left-right direction, or the up-down direction of the vehicle. The front-rear direction in FIG. 1 is a stacking direction of the fuel cell stack 100, and when assembling the fuel cell stack 100, the stacking direction is aligned with the direction of gravity.

As illustrated in FIG. 1, the fuel cell stack 100 includes a cell stacked body 10, end units 40 disposed on both ends in the front-rear direction of the cell stacked body 10, and a case 30 surrounding the cell stacked body 10, and the whole of the fuel cell stack 100 has a substantially rectangular parallelepiped shape.

The case 30 has four substantially rectangular side walls 300, each facing the top, right, bottom, and left surfaces of the cell stacked body 10. These four side walls 300 form a substantially box-shaped housing space SP0 with open the front and rear surfaces. The case 30 is composed of metals such as aluminum or iron.

Although not illustrated, the end unit 40 has a plurality of plates stacked in the front-rear direction. More specifically, the end units 40 include terminal plates arranged adjacent to both front and rear end surfaces of the cell stacked body 10, insulating plates arranged outside the terminal plates in the front-rear direction, and end plates arranged outside the insulating plates in the front-rear direction.

The terminal plate is a substantially rectangular metal plate member and has a terminal portion for extracting power generated by electrochemical reactions in the cell stacked body 10. The insulating plate is a substantially rectangular plate member made of non-conductive resin or rubber, and electrically insulates the terminal plate and the end plate. The end plate is a plate member made of metal or high-strength resin.

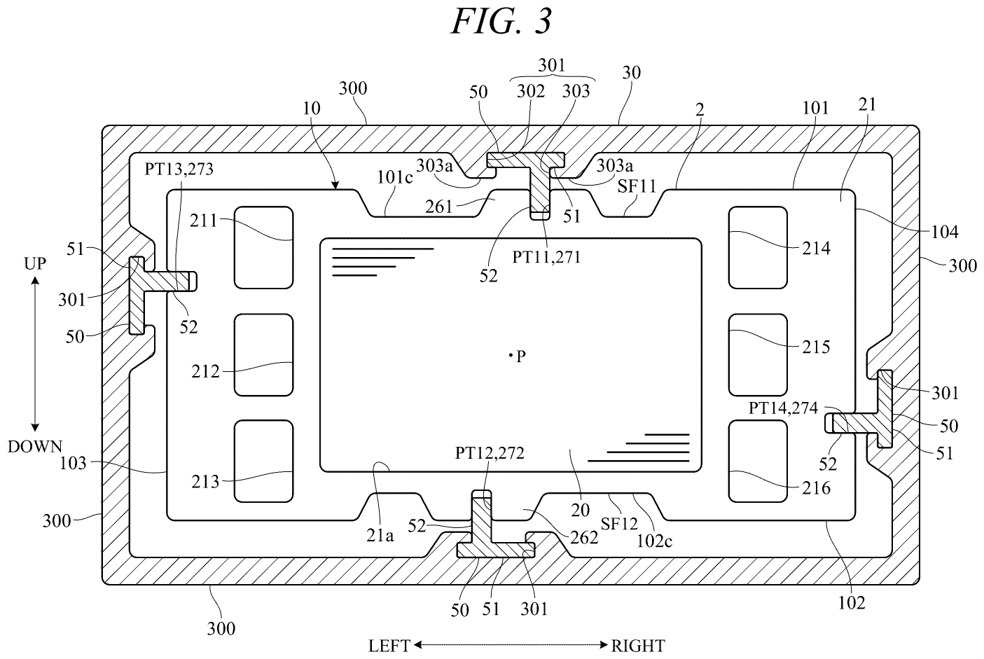

A guide member 50 (FIG. 3) is interposed between the cell stacked body 10 and each side wall 300 of the case 30. The guide member 50 is a rod-like or plate-like member extending in the front-rear direction. The guide member 50 is previously attached to each of the inner surfaces of the four side walls 300 (the inner wall of the case 30), and the cell stacked body 10 is assembled in this state.

In part “A” of FIG. 1, a portion of the side wall 300 of the case 30 is shown as broken. As illustrated in part “A” of FIG. 1, the cell stacked body 10 is a stacked body including a plurality of power generation cells 1 (for convenience, only a single cell 1 is illustrated). The cell stacked body 10 is configured by stacking in the front-rear direction while being guided by the guide member 50.

The power generation cell 1 has a unitized electrode assembly (hereinafter, referred to as a “UEA”) 2, and separators 3 arranged on both front and rear sides of the UEA 2 to sandwich the UEA 2. The UEA 2 and the separator 3 are alternately arranged in the front-rear direction. The separator 3 disposed facing the front surface of the UEA 2 is sometimes referred to as a first separator 31, and the separator 3 disposed facing the rear surface is referred to as a second separator 32. Depending on which UEA 2 is used as a reference, the same separator 3 may become the first separator 31 or the second separator 32.

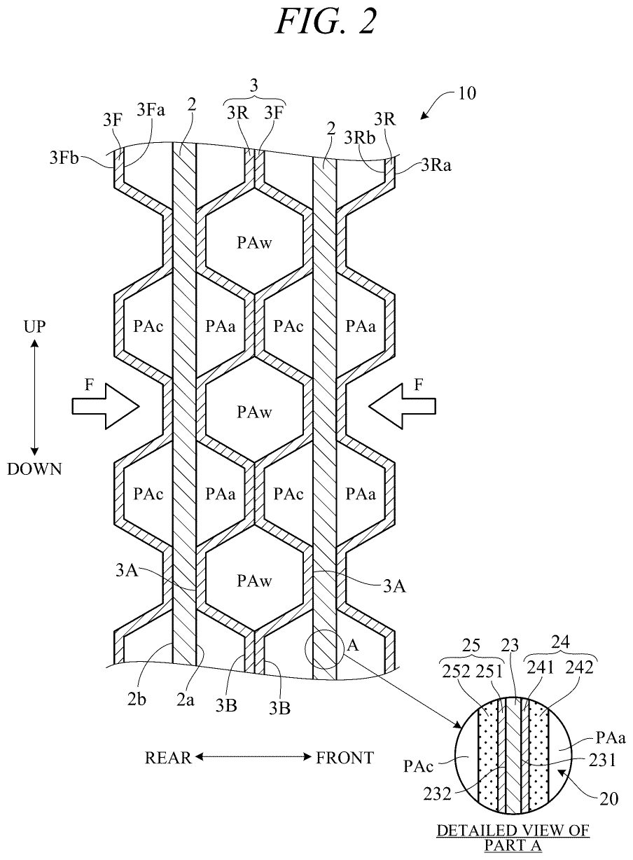

FIG. 2 is a cross-sectional view of a main part of the cell stacked body 10. As shown in FIG. 2, the separator 3 has a front plate 3F and a rear plate 3R, which are a pair of metal thin plates with a corrugated cross-section. The front plate 3F extends in the up-down and left-right directions and has a front surface 3Fa and a rear surface 3Fb. The rear plate 3R extends in the up-down, and left-right directions, and has a front surface 3Ra and a rear surface 3Rb. The rear surface 3Fb of the front plate 3F and the front surface 3Ra of the rear plate 3R facing each other are joined together by welding or the like at their outer peripheral edges. Thus, the front plate 3F and the rear plate 3R are integrally joined to form a separator 3. The separator 3 uses a conductive material with excellent corrosion resistance, such as stainless steel, titanium, or titanium alloy.

Inside the separator 3 enclosed by the front plate 3F and the rear plate 3R, that is, between the rear surface 3Fb of the front plate 3F and the front surface 3Ra of the rear plate 3R, a cooling flow path PAw through which a cooling medium flows is formed. The generating surface of the power generation cell 1 is cooled by the flow of the cooling medium. Water, for example, can be used as the cooling medium. The surfaces of the separator 3 facing the UEA 2, that is, the front surface 3Fa of the front plate 3F and the rear surface 3Rb of the rear plate 3R, are formed into an uneven shape by press molding or the like to form a gas flow path between the separator 3 and the UEA 2. More specifically, the separator 3 has a pair of front and rear rib portions 3A protruding towards the UEA 2, and a pair of front and rear concave portions 3B, which are concavely formed in continuation to the pair of front and rear rib portions 3A.

The pair of front and rear rib portions 3A contact the front surface 2a and the rear surface 2b of the UEA 2. In the cell stacked body 10, a compressive load F is applied in the front-rear direction during the assembly of the fuel cell stack 100, and this compressive load F is maintained after the assembly of the fuel cell stack 100 is completed. Therefore, a predetermined surface pressure due to the compressive load F acts in the front-rear direction on the UEA 2 through the rib portion 3A.

Between the front surface 2a of the UEA 2 and the rear plate 3R of the separator 3 facing this front surface 2a, an anode flow path PAa through which fuel gas including hydrogen (anode gas) flows is formed by the concave portion 3B. Between the rear surface 2b of the UEA 2 and the front plate 3F of the separator 3 facing this rear surface 2b, a cathode flow path PAc through which oxidant gas including oxygen (cathode gas) flows is formed by the concave portion 3B. For example, hydrogen gas can be used as the fuel gas, and air can be used as the oxidant gas. The fuel gas and the oxidant gas may be referred to as a reaction gas without being distinguished from each other.

FIG. 3 is a cross-sectional view of a main part in FIG. 1 showing a schematic configuration of the UEA 2 (cross-sectional view taken along line III-III in FIG. 1). The UEA 2 can also be referred to as a membrane electrode structure or a membrane electrode member. As shown in FIG. 3, the UEA 2 includes a substantially rectangular membrane electrode assembly 20 (hereinafter, referred to as a “MEA”) and a frame 21 that supports the MEA 20. As shown in the detailed view of part “A” in FIG. 2, the MEA 20 has an electrolyte membrane 23, an anode electrode 24 provided on a front surface 231 of the electrolyte membrane 23, and a cathode electrode 25 provided on a rear surface 232 of the electrolyte membrane 23.

The electrolyte membrane 23 is, for example, a solid polymer electrolyte membrane, and a thin film of perfluorosulfonic acid polymer containing moisture can be used. Not only a fluorine-based electrolyte but also a hydrocarbon-based electrolyte can be used.

The anode electrode 24 has an electrode catalyst layer 241 formed on the front surface 231 of the electrolyte membrane 23 and served as a reaction field for electrode reaction, and a gas diffusion layer 242 formed on the front surface of the electrode catalyst layer 241 to spread and supply the fuel gas. An intermediate layer (underlayer) can also be provided between the electrode catalyst layer 241 and the gas diffusion layer 242. The cathode electrode 25 has an electrode catalyst layer 251 formed on the rear surface 232 of the electrolyte membrane 23 and served as a reaction field for electrode reaction, and a gas diffusion layer 252 formed on the rear surface of the electrode catalyst layer 251 to spread and supply the oxidant gas. An intermediate layer (underlayer) can also be provided between the electrode catalyst layer 251 and the gas diffusion layer 252.

The electrode catalyst layers 241 and 251 include a catalyst metal that promotes the electrochemical reaction of hydrogen contained in the fuel gas and oxygen contained in the oxidant gas, an electrolyte (such as an ionomer) with proton conductivity, and carbon particles with electron conductivity, and the like. The gas diffusion layers 242 and 252 are made of conductive members with gas permeability, such as carbon porous bodies.

In the anode electrode 24, the fuel gas (hydrogen) supplied through the anode flow path PAa is ionized by an action of a catalyst, passes through the electrolyte membrane 23, and moves to the cathode electrode side. Electrons generated at this time pass through an external circuit and are extracted as electric energy. In the cathode electrode 25, an oxidant gas (oxygen) supplied via the cathode flow path PAc reacts with hydrogen ions guided from the anode electrode 24 and electrons moved from the anode electrode 24 to generate water. The generated water gives an appropriate humidity to the electrolyte membrane 23, and excess water is discharged to an outside of the UEA 2 along the gas flow.

As illustrated in FIG. 3, the frame 21 is a thin plate having a substantially rectangular shape, and is made of an insulating resin, rubber, or the like. A substantially rectangular opening 21a is provided in a central portion of the frame 21. The MEA 20 is disposed to cover the entire opening 21a and a peripheral portion of the MEA 20 is supported by the frame 21. Three through-holes 211 to 213 penetrating the frame 21 in the front-rear direction are opened side by side in the up-down direction on the left side of the opening 21a of the frame 21. Three through-holes 214 to 216 penetrating the frame 21 in the front-rear direction are opened side by side in the up-down direction on the right side of the opening 21a of the frame 21. The through-holes 211 to 216 are all shown as rectangular for convenience, but the shape of the through-holes 211 to 216 is not limited to this. A point P in FIG. 3 is an intermediate point in the left-right direction and an intermediate point in the up-down direction of the cell stacked body 10, and is referred to as a center point.

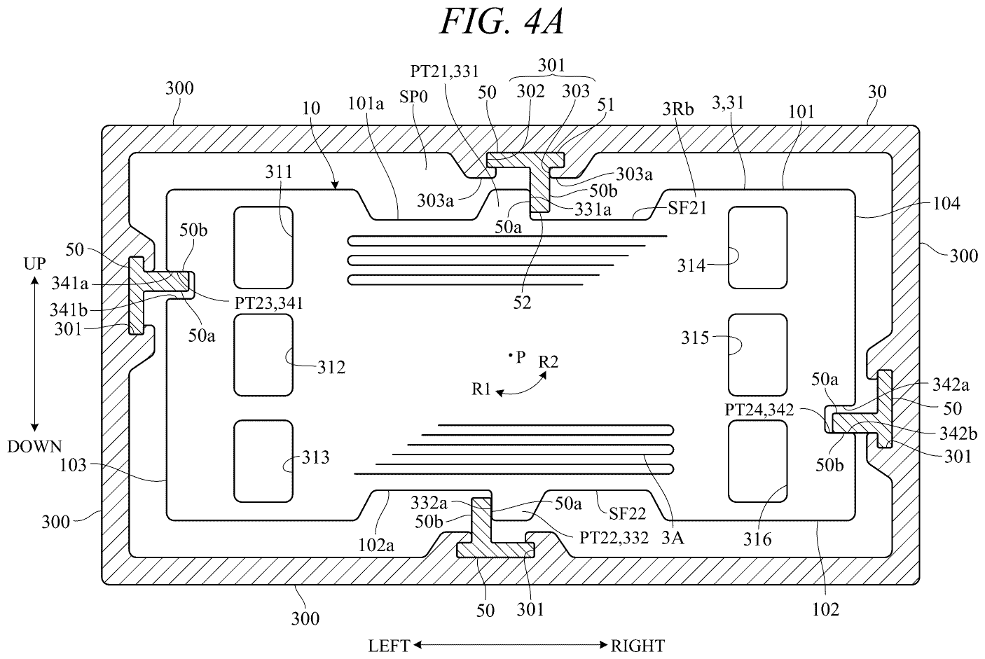

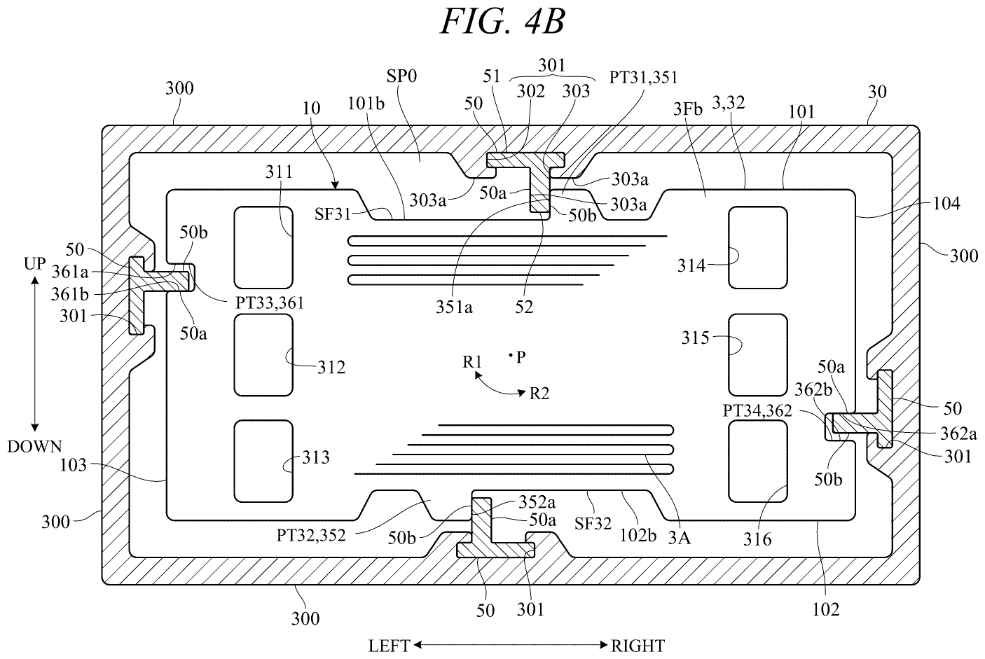

FIG. 4A is a cross-sectional view of a main part of FIG. 1 showing a configuration of the rear surface of the first separator 31 (rear surface 3Rb of the rear plate 3R) arranged in front of UEA 2, and FIG. 4B is a cross-sectional view of a main part of FIG. 1 showing a configuration of the rear surface of the second separator 32 (rear surface 3Fb of the front plate 3F) arranged behind UEA 2. Although some illustrations are omitted, in the central part in the left-right direction of the rear surface 3Rb, a plurality of rib portions 3A facing the MEA 20 of UEA 2 are extended in the left-right direction. Although detailed illustrations are omitted, the rib portion 3A extends in the left-right direction while meandering.

As shown in FIGS. 4A and 4B, in the separator 3 (first separator 31 and second separator 32), through-holes 311 to 316 penetrating the separators 3 in the front-rear direction are opened at positions corresponding to the through-holes 211 to 216 (FIG. 3) of the frame 21. The through-holes 311 to 316 are all shown as rectangular for convenience, but the shape of the through-holes 311 to 316 is not limited to this. The through-holes 311 to 316 communicate with the through-holes 211 to 216 of the frame 21, respectively. The set of the through-holes 211 to 216 and 311 to 316 communicating with each other forms a plurality of flow paths penetrating the cell stacked body 10 and extending in the front-rear direction. Although not illustrated, a plurality of bead portions for sealing, that is, metal bead seals, are provided around the through-holes 311 to 316 of the separator 3 and the peripheral portions of the separator 3, protruding toward the frame 21.

As shown in FIG. 1, in the rear end unit 40, a plurality of through-holes 401 to 406 penetrating the end unit 40 in the front-rear direction are opened at positions corresponding to the through-holes 211 to 216 and 311 to 316. In the front end unit 40, the through-holes 401 to 406 are not opened. The front end unit 40 may be referred to as a dry side end unit, and the rear end unit 40 as a wet side end unit. The through-holes 401 to 406 are all shown as rectangular for convenience, but the shape of the through-holes 401 to 406 is not limited to this.

A fuel gas tank storing high-pressure fuel gas is connected to the through-hole 401 via an ejector, an injector, etc., and the fuel gas is supplied to the fuel cell stack 100 through the through-hole 401, as shown by a solid arrow. This fuel gas is guided to the anode flow path PAa between the UEA 2 and the rear plate 3R of the separator 3 through the through-holes 211 and 311. The fuel gas after passing through the anode flow path PAa, that is, fuel exhaust gas (anode off-gas) is discharged from the through-hole 406 through the through-holes 216 and 316, as shown in a solid arrow.

A compressor for supplying oxidant gas is connected to the through-hole 404, and the oxidant gas compressed by the compressor is supplied to the fuel cell stack 100 through the through-hole 404, as shown in a dotted arrow. This oxidant gas is guided to the cathode flow path PAc between the UEA 2 and the front plate 3F of the separator 3 through the through-holes 214 and 314. The oxidant gas after passing through the cathode flow path Pac, that is, oxidant exhaust gas (cathode off-gas) is discharged from the through-hole 403 through the through-holes 213 and 313, as shown in a dotted arrow.

A pump for supplying cooling medium is connected to the through-hole 405, and the cooling medium is supplied to the fuel cell stack 100 through the through-hole 405, as shown in a chain arrow. This cooling medium is guided to the cooling flow path PAw between the front plate 3F and the rear plate 3R of the separator 3 through the through-holes 215 and 315. The cooling medium after passing through the cooling flow path PAw is discharged from the through-hole 402 through the through-holes 212 and 312, as shown in a chain arrow. The discharged cooling medium is cooled by heat exchange in a radiator and is supplied again to the fuel cell stack 100 through the through-hole 405.

A schematic configuration of the fuel cell stack 100 has been described above. The fuel cell stack 100 according to the present embodiment is characterized by a support structure of the cell stacked body 10 supported from the inner wall of the case 30. The cell stacked body 10 is configured by stacking the power generation cell 1 (UEA 2, separator 3) in the housing space SP0 in the case 30 while positioning the power generation cell 1 via the guide member 50. For this reason, the fuel cell stack 100 needs to be configured not only to accurately position the power generation cell 1 but also to easily stack the power generation cell 1. In the present embodiment, in consideration of this point, the fuel cell stack 100 is configured as follows.

FIGS. 3, 4A, and 4B are views as viewed from the stacking direction of the cell stacked body 10. As illustrated in FIGS. 3, 4A, and 4B, the guide members 50 having the same shape are interposed between the four side walls 300 of the case 30 and the four side surfaces (upper side surface 101, lower side surface 102, left side surface 103, right side surface 104) of the cell stacked body 10. The cell stacked body 10 has a substantially rectangular shape with the upper side surface 101 and the lower side surface 102 as long sides and the left side surface 103 and the right side surface 104 as short sides.

The guide member 50 has an elongated base portion 51 extending along the side wall 300 and a protruding portion 52 protruding substantially vertically from the base portion 51, and has a substantially T-shaped cross section as a whole. More specifically, the protruding portion 52 protrudes not from the central portion of the base portion 51 but from a position shifted to one end side from the central portion. The four guide members 50 may not have the same shape but may have different shapes. For example, the upper and lower guide members 50 may have the same shape, and the guide members 50 may have different shapes from the right and left guide members 50.

The guide member 50 is formed by, for example, extrusion molding or the like using resin as a constituent material, and has a constant cross-sectional shape in the front-rear direction. The guide member 50 extends over the entire length in the front-rear direction of the fuel cell stack 100. The front end portion of the guide member 50 is supported by the front end unit 40 in FIG. 1, and the rear end portion is supported by the rear end unit 40. For example, a recessed portion or a through-hole is provided in the end unit 40, and the front end portion and the rear end portion of the guide member 50 are fitted or inserted into the recessed portion or the through-hole to support the guide member 50.

Support portions 301 are provided on the four side walls 300 of the case 30 so as to face the housing space SP0. The support portion 301 has an engaging groove 302 extending substantially parallel to each of the side surfaces 101 to 104 of the cell stacked body 10, and an inlet portion 303 which is an inlet of the engaging groove 302. When a direction extending along the side surfaces 101 to 104 as viewed from the stacking direction is defined as a length direction, and a direction perpendicular to the length direction is defined as a width direction, the inlet portion 303 has a pair of protruding portions 303a protruding inward from both ends in the length direction of the engaging groove 302 so as to narrow the inlet of the engaging groove 302.

The length and the width of the engaging groove 302 are the same as or substantially the same as the length and the width of the base portion 51 of the guide member 50, and the base portion 51 is fitted into the engaging groove 302. As a result, the position of the base portion 51 is constrained by the protruding portion 303a and is integrally supported with the side wall 300. At this time, the tip portion of the protruding portion 52 protrudes toward the center point P beyond the inlet portion 303.

As illustrated in FIGS. 4A and 4B, the protruding portion 52 has a pair of end surfaces 50a and 50b extending toward the center point P. In a state where the guide member 50 is supported by the support portion 301, the protruding portion 52 of the upper guide member 50 facing the upper side surface 101 of the cell stacked body 10 is located on the right side of the center point P, and the protruding portion 52 of the lower guide member 50 facing the lower side surface 102 is located on the left side of the center point P. More specifically, the upper protruding portion 52 and the lower protruding portion 52 are positioned symmetrically with respect to the center point P. Therefore, the distance from the center point P to the left end surface 50a of the upper protruding portion 52 is the same as the distance from the center point P to the right end surface 50a of the lower protruding portion 52. In addition, the distance from the center point P to the right end surface 50b of the upper protruding portion 52 is the same as the distance from the center point P to the left end surface 50b of the lower protruding portion 52.

In a state where the guide member 50 is supported by the support portion 301, the protruding portion 52 of the upper guide member 50 facing the left side surface 103 of the cell stacked body 10 is located on the upper side of the center point P, and the protruding portion 52 of the right guide member 50 facing the right side surface 104 is located on the lower side of the center point P. More specifically, the left protruding portion 52 and the right protruding portion 52 are positioned symmetrically with respect to the center point P. Therefore, the distance from the center point P to the upper end surface 50b of the left protruding portion 52 is the same as the distance from the center point P to the lower end surface 50b of the right protruding portion 52. In addition, the distance from the center point P to the lower end surface 50a of the left protruding portion 52 is the same as the distance from the center point P to the upper end surface 50a of the right protruding portion 52.

Positioning portions PT11 to PT14, PT21 to PT24, and PT31 to PT34 are provided on the upper side surface 101, the lower side surface 102, the left side surface 103, and the right side surface 104 of the UEA 2, the first separator 31, and the second separator 32, respectively, corresponding to the guide member 50. The UEA 2, the first separator 31, and the second separator 32 are positioned with respect to the case 30 via the guide member 50 and the positioning portions PT11 to PT14, PT21 to PT24, and PT31 to PT34.

As illustrated in FIG. 4A, a recessed portion 101a is provided at the central portion of the upper side surface 101 of the first separator 31 in the left-right direction. A substantially rectangular protruding portion 331 protruding upward from a bottom surface SF21 of the recessed portion 101a is provided as the positioning portion PT21 in the central portion of the recessed portion 101a. The vertical position, that is, the position in the up-down direction, of the upper end surface of the protruding portion 331 is substantially the same as the vertical position of the upper side surface 101 on both left and right sides of the recessed portion 101a. A right end surface 331a of the protruding portion 331 extends in the up-down direction, that is, perpendicular to the upper side surface 101 so as to abut on the end surface 50a of the guide member 50.

Similarly, a recessed portion 102a is provided at the central portion of the lower side surface 102 of the first separator 31 in the left-right direction. At the central portion of the recessed portion 102a, a substantially rectangular protruding portion 332 protruding downward from a bottom surface SF22 of the recessed portion 102a is provided as the positioning portion PT22. The vertical position of the lower end surface of the protruding portion 332 is substantially the same as the vertical position of the lower side surface 102 on both left and right sides of the recessed portion 102a. The left end surface 332a of the protruding portion 332 extends in the up-down direction, that is, perpendicular to the lower side surface 102 so as to abut on the end surface 50a of the guide member 50.

The protruding portion 331 and the protruding portion 332 are provided symmetrically with respect to the center point P. Therefore, the distance from the center point P to the right end surface 331a of the protruding portion 331 and the distance from the center point P to the left end surface 332a of the protruding portion 332 are equal to each other.

The left side surface 103 and the right side surface 104 of the first separator 31 are provided with substantially rectangular recessed portions 341 and 342 as positioning portions PT23 and PT24, respectively. The widths (lengths in the up-down direction) of the recessed portions 341 and 342 are larger than the width of the protruding portion 52 of the guide member 50. The protruding portion 52 of the left guide member 50 is inserted into the recessed portion 341, and the protruding portion 52 of the right guide member 50 is inserted into the recessed portion 342. The recessed portion 341 and the recessed portion 342 are provided symmetrically with respect to the center point P.

More specifically, the left recessed portion 341 is provided such that an upper end surface 341a abuts on the end surface 50b of the guide member 50 above the center point P, and a lower end surface 341b and the end surface 50a of the guide member 50 are separated from each other. The right recessed portion 342 is provided such that a lower end surface 342b abuts on the end surface 50b of the guide member 50 below the center point P, and an upper end surface 342a and the end surface 50a of the guide member 50 are separated from each other.

As described above, in the present embodiment, since the right end surface 331a of the upper protruding portion 331 and the left end surface 332a of the lower protruding portion 332 of the first separator 31 abut on the left end surface 50a of the upper guide member 50 and the right end surface 50a of the lower guide member 50, respectively, the movement of the first separator 31 in the left-right direction can be prevented. In addition, since the upper end surface 341a of the left recessed portion 341 and the lower end surface 342b of the right recessed portion 342 of the first separator 31 abut on the upper end surface 50b of the left guide member 50 and the lower end surface 50b of the right guide member 50, respectively, the movement of the first separator 31 in the up-down direction can be prevented.

Furthermore, since the right end surface 331a of the protruding portion 331 and the left end surface 332a of the protruding portion 332 abut on the guide member 50, the clockwise rotation (direction of arrow R1) of the first separator 31 about the center point P is prevented. Since the upper end surface 341a of the recessed portion 341 and the lower end surface 342b of the recessed portion 342 are in contact with the guide member 50, counterclockwise rotation of the first separator 31 about the center point P (direction of arrow R2) is prevented. As a result, movement and rotation of the first separator 31 with respect to the case 30 are prevented, so that the first separator 31 can be accurately positioned and held in the housing space SP0 of the case 30 in a state of being separated from the inner wall (side wall 300) of the case 30.

As illustrated in FIG. 4B, a recessed portion 101b is provided at the central portion of the upper side surface 101 of the second separator 32 in the left-right direction. A substantially rectangular protruding portion 351 protruding upward from a bottom surface SF31 of the recessed portion 101b is provided as the positioning portion PT31 in the central portion of the recessed portion 101b. The vertical position of the upper end surface of the protruding portion 351 is substantially the same as the vertical position of the upper side surface 101 on both left and right sides of the recessed portion 101b. A left end surface 351a of the protruding portion 351 extends in the up-down direction, that is, perpendicular to the upper side surface 101 so as to abut on the end surface 50b of the guide member 50.

Similarly, a recessed portion 102b is provided at the central portion of the lower side surface 102 of the second separator 32 in the left-right direction. At the central portion of the recessed portion 102b, a substantially rectangular protruding portion 352 protruding downward from a bottom surface SF32 of the recessed portion 102b is provided as the positioning portion PT32. The vertical position of the lower end surface of the protruding portion 352 is substantially the same as the vertical position of the lower side surface 102 on both left and right sides of the recessed portion 102b. The right end surface 352a of the protruding portion 352 extends in the up-down direction, that is, perpendicular to the lower side surface 102 so as to abut on the end surface 50a of the guide member 50.

The protruding portion 351 and the protruding portion 352 are provided symmetrically with respect to the center point P. Therefore, the distance from the center point P to the left end surface 351a of the protruding portion 351 and the distance from the center point P to the right end surface 352a of the protruding portion 352 are equal to each other.

The left side surface 103 and the right side surface 104 of the second separator 32 are provided with substantially rectangular recessed portions 361 and 362 as positioning portions PT33 and PT34, respectively. The widths (lengths in the up-down direction) of the recessed portions 361 and 362 are larger than the width of the protruding portion 52 of the guide member 50. The protruding portion 52 of the left guide member 50 is inserted into the recessed portion 361, and the protruding portion 52 of the right guide member 50 is inserted into the recessed portion 362. The recessed portion 361 and the recessed portion 362 are provided symmetrically with respect to the center point P.

More specifically, the left recessed portion 361 is provided such that a lower end surface 361b abuts on the end surface 50a of the guide member 50 above the center point P, and an upper end surface 361a and the end surface 50b of the guide member 50 are separated from each other. The right recessed portion 362 is provided such that an upper end surface 362a abuts on the end surface 50b of the guide member 50 below the center point P, and a lower end surface 362b and the end surface 50b of the guide member 50 are separated from each other.

As described above, in the present embodiment, since the left end surface 351a of the upper protruding portion 351 and the right end surface 352a of the lower protruding portion 352 of the second separator 32 abut on the right end surface 50b of the upper guide member 50 and the left end surface 50b of the lower guide member 50, respectively, the movement of the second separator 32 in the left-right direction can be prevented. In addition, since the lower end surface 361b of the left recessed portion 361 and the upper end surface 362a of the right recessed portion 362 of the second separator 32 abut on the lower end surface 50a of the left guide member 50 and the upper end surface 50a of the right guide member 50, respectively, the movement of the second separator 32 in the up-down direction can be prevented.

Furthermore, since the left end surface 351a of the protruding portion 351 and the right end surface 352a of the protruding portion 352 abut on the guide member 50, the counterclockwise rotation (direction of arrow R2) of the second separator 32 about the center point P is prevented. Since the lower end surface 361b of the recessed portion 361 and the upper end surface 362a of the recessed portion 362 are in contact with the guide member 50, clockwise rotation of the second separator 32 about the center point P (direction of arrow R1) is prevented. As a result, movement and rotation of the second separator 32 with respect to the case 30 are prevented, so that the second separator 32 can be accurately positioned and held in the housing space SP0 of the case 30 in a state of being separated from the inner wall (side wall 300) of the case 30.

As illustrated in FIGS. 4A and 4B, the protruding portions 331 and 332 of the first separator 31 and the protruding portions 351 and 352 of the second separator 32 are disposed on opposite sides in the left-right direction with the guide member 50 interposed therebetween. Therefore, the protruding portions 331 and 332 of the first separator 31 and the protruding portions 351 and 352 of the second separator 32 are shifted in position in the left-right direction without overlapping each other when viewed from the stacking direction (front-rear direction). That is, the right end surface 331a of the protruding portion 331 is located on the left side of the left end surface 351a of the protruding portion 351, and the left end surface 332a of the protruding portion 332 is located on the right side of the right end surface 352a of the protruding portion 352. This makes it possible to increase the insulation distance between the protruding portions 331 and 332 and the protruding portions 351 and 352.

As illustrated in FIG. 3, a recessed portion 101c is provided at the central portion of the upper side surface 101 of the frame 21 of the UEA 2 in the left-right direction. A substantially rectangular protruding portion 261 protruding upward from a bottom surface SF11 of the recessed portion 101c is provided in the central portion of the recessed portion 101c. The vertical position of the upper end surface of the protruding portion 261 is substantially the same as the vertical position of the upper side surface 101 on both left and right sides of the recessed portion 101c. Similarly, a recessed portion 102c is provided at the central portion of the lower side surface 102 of the frame 21 of the UEA 2 in the left-right direction. A substantially rectangular protruding portion 262 protruding downward from a bottom surface SF12 of the recessed portion 102c is provided in a central portion of the recessed portion 102c. The vertical position of the lower end surface of the protruding portion 262 is substantially the same as the vertical position of the lower side surface 102 on both left and right sides of the recessed portion 102c.

The protruding portion 261 is provided on the right side of the protruding portion 262. Substantially rectangular recessed portions 271 and 272 are provided as the positioning portions PT11 and PT12 at the central portion of the protruding portion 261 in the left-right direction and the central portion of the protruding portion 262 in the left-right direction, respectively. The recessed portion 271 and the recessed portion 272 are provided symmetrically with respect to the center point P. The widths (lengths in the left-right direction) of the recessed portions 271 and 272 are substantially the same as the width of the protruding portion 52 of the guide member 50. The protruding portion 52 of the upper guide member 50 is fitted into the recessed portion 271, and the protruding portion 52 of the lower guide member 50 is fitted into the recessed portion 272. As a result, the movement of the UEA 2 in the left-right direction can be prevented.

On the left side surface 103 and the right side surface 104 of the frame 21 of the UEA 2, substantially rectangular recessed portions 273 and 274 are provided as the positioning portions PT13 and PT14, respectively. The recessed portion 273 and the recessed portion 274 are provided symmetrically with respect to the center point P. The widths (lengths in the up-down direction) of the recessed portions 273 and 274 are substantially the same as the width of the protruding portion 52 of the guide member 50. The protruding portion 52 of the left guide member 50 is fitted into the recessed portion 273, and the protruding portion 52 of the right guide member 50 is fitted into the recessed portion 274. As a result, the movement of the UEA 2 in the up-down direction can be prevented.

The separator 3 is made of metal, whereas the frame 21 is made of resin or rubber. Therefore, the frame 21 has lower rigidity than the separator 3, and is easily deformed. Therefore, the protruding portion 52 can be easily fitted into the recessed portions 271 to 274. Instead of providing the recessed portion 271 to 274 in the frame 21, similarly to the separator 3 in FIGS. 4A and 4B, a protruding portion or a recessed portion wider than the recessed portions 271 to 274 may be provided, and only one end surface of the protruding portion 52 may abut on one end surface of the protruding portion or the wide recessed portion.

The protruding portions 261 and 262 of the frame 21 are interposed between the protruding portions 331 and 332 of the first separator 31 and the protruding portions 351 and 352 of the second separator 32. Since the widths of the recessed portions 273 and 274 of the frame 21 are narrow, a portion other than the recessed portions 273 and 274 of the frame 21 is interposed between the recessed portions 341 and 342 of the first separator 31 and the recessed portions 361 and 362 of the second separator 32. Thus, the separators can be well insulated from each other.

Although not illustrated, in the present embodiment, the length in the up-down direction and the length in the left-right direction of the UEA 2 are longer than the length in the up-down direction and the length in the left-right direction of the separator 3.

Therefore, when viewed from the stacking direction, the entire separator is covered with the UEA 2. Accordingly, the upper end portion and the lower end portion of the frame 21 are positioned above and below the upper end portion and the lower end portion of the separator 3, and the left end portion and the right end portion of the frame 21 are positioned to the left and right of the left end portion and the right end portion of the separator 3. Thus, the separators can be reliably insulated from each other.

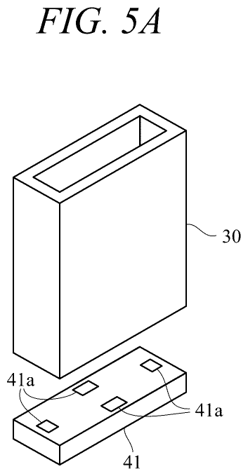

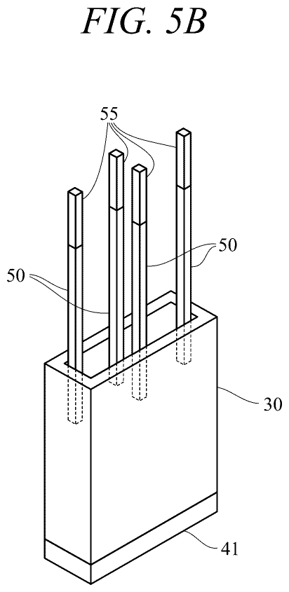

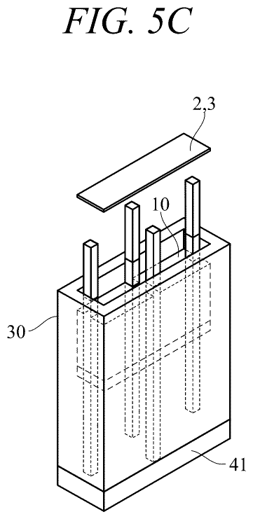

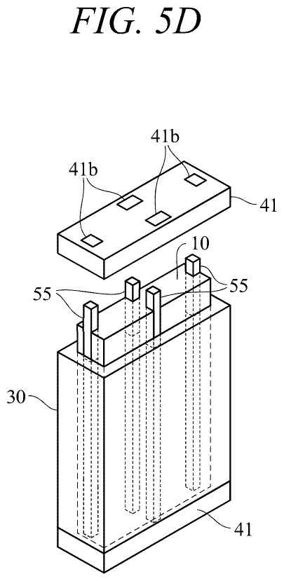

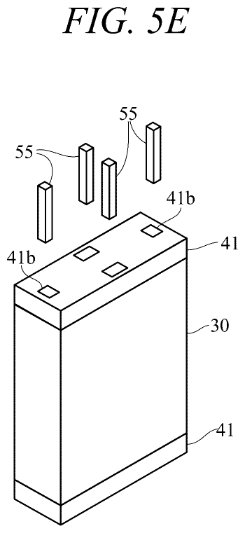

The assembly method of the fuel cell stack 100 according to the present embodiment will be described. FIGS. 5A to 5E are diagrams illustrating an example of an assembly procedure of the fuel cell stack 100. When the fuel cell stack 100 is subjected to an assembling operation, the guide member 50 is manufactured in advance by extrusion molding, and the guide member 50 having a predetermined length is prepared (preparation process). Next, as illustrated in FIG. 5A, the case 30 is fixed to the end plate 41 of the end unit 40 on the wet side (front side in FIG. 1) using bolts (case attachment process). On the upper surface of the end plate 41, a recessed portion 41a is provided corresponding to the position of the guide member 50.

Next, as illustrated in FIG. 5B, the guide member 50 is inserted from above the case 30 along the engaging groove 302 provided on the inner surface of the side wall 300 of the case 30. Then, the lower end portion of the guide member 50 is fitted into the recessed portion 41a on the upper surface of the end plate 41 (guide insertion process). At this time, before or after the fitting of the guide member 50, an extension guide member 55 having the same cross-sectional shape as the guide member 50 is attached to the upper end surface of the guide member 50 (extension guide attaching process). For example, a pin is provided to protrude from the lower end surface of the extension guide member 55, a bottomed recessed portion is provided on the upper end surface of the guide member 50, and the extension guide member 55 is detachably attached to the guide member 50 by fitting the pin into the bottomed recessed portion.

Next, an insulating plate and a terminal plate on the wet side are inserted into the case 30 along the extension guide member 55 and the guide member 50, and sequentially stacked. Further, as illustrated in FIG. 5C, a predetermined number of UEAs 2 and separators 3 are accommodated and stacked in the case 30 from above along the extension guide member 55 and the guide member 50 (stacking process). Thus, the cell stacked body 10 is configured.

In this case, the end surfaces 50a and 50b of the protruding portion 52 of the guide member 50 and the end surfaces 331a, 332a, 351a, and 352a of the protruding portions 331, 332, 351, and 352 of the separator 3 are in contact with each other, and the end surfaces 50a and 50b of the protruding portion 52 of the guide member 50 and the end surfaces 341a, 342b, 361b, and 362a of the recessed portion 341, 342, 361, and 362 of the separator 3 are in contact with each other, so that the separator 3 is stacked in the case 30 while being positioned with respect to the case 30. Further, the protruding portion 52 of the guide member 50 is fitted into the recessed portions 271 to 274 of the UEA 2, and the UEA 2 is stacked in the case 30 while being positioned with respect to the case 30. As a result, the cell stacked body 10 can be configured in a state where the UEA 2 and the separator 3 are accurately positioned.

In particular, only one of the pair of end surfaces 50a and 50b of the protruding portion 52 of the guide member 50 abuts on the protruding portions 331, 332, 351, and 352 and the recessed portions 341, 342, 361, and 362 of the separator 3. Therefore, frictional resistance when the separator 3 is lowered along the guide member 50, is small, and the separator 3 can be easily stacked. A set of unit cells may be formed by integrally joining a single UEA 2 and a single separator 3 (for example, the second separator 32) in advance, and the unit cells may be lowered in the case 30 along the extension guide member 55 and the guide member 50 by a predetermined number of sets to form the cell stacked body 10.

Next, the terminal plate and the insulating plate on the dry side (rear side of FIG. 1) are lowered along the extension guide member 55 and sequentially stacked, and then the end plate 41 on the dry side is lowered along the extension guide member 55 as illustrated in FIG. 5D. More specifically, the end plate 41 on the dry side has a through-hole 41b opened at a position corresponding to the guide member 50, and the end plate 41 is placed above the cell stacked body 10 (strictly, the insulating plate) while the extension guide member 55 is inserted into the through-hole 41b of the end plate 41 (final stacking process). Thereafter, a pressurizing force is applied from above the end plate 41 using a pressurizer (not illustrated), and the end plate 41 on the dry side is fixed to the case 30 using a bolt in a state where the height of the end plate 41 on the dry side is maintained at a predetermined height (fixing process). In this state, the extension guide member 55 protrudes upward from the end plate 41 on the dry side.

Next, as illustrated in FIG. 5E, the extension guide member 55 is pulled out from the guide member 50 via the through-hole 41b (pulling-out process). Finally, the through-hole 41b of the end plate 41 is covered with a cover (not illustrated) via a sealing material to seal the through-hole 41b (sealing process). The cover is fastened to the end plate 41 using, for example, a bolt. Thus, assembly of the fuel cell stack 100 is completed.

According to the present embodiment, the following operations and effects can be achieved.

(1) The fuel cell stack 100 includes: the cell stacked body 10 formed by stacking the power generation cells 1 having the UEA 2 including the electrolyte membrane 23, the anode electrode 24, and the cathode electrode 25, and the separator 3; the case 30 surrounding the cell stacked body 10; the guide member 50 protruding from an inner wall of the case 30 toward the cell stacked body 10 and extending along a stacking direction of the cell stacked body 10; and the positioning portions PT11 to PT14, PT21 to PT24, and PT31 to PT34 which are provided at edges (upper side surface 101, lower side surface 102, left side surface 103, and right side surface 104) of the power generation cell 1 corresponding to the guide member 50 and position the power generation cell 1 with respect to the case 30 (FIGS. 1 to 4B). The positioning portions PT21, PT22, PT31, and PT32 have the protruding portions (a first protruding portions) 331 and 351 and the protruding portions (a second protruding portions) 332 and 352 protruding toward the inner wall from the upper side surface 101 and the lower side surface 102 of the power generation cell 1 facing the inner wall of the case 30, respectively (FIGS. 4A and 4B). The protruding portions 331 and 351 and the protruding portions 332 and 352 have the end surfaces 331a and 351a extending substantially perpendicularly from the upper side surface 101 and the end surfaces 332a and 352a extending substantially perpendicularly from the lower side surface 102, respectively (FIGS. 4A and 4B). The guide member 50 includes the upper guide member 50 having the end surfaces 50a and 50b which are provided on the right side of the protruding portion 331 and the left side of the protruding portion 351 and abut on the end surfaces 331a and 351a, respectively, and the lower guide member 50 having the end surfaces 50a and 50b which are provided on the left side of the protruding portion 332 and the right side of the protruding portion 352 and abut on the end surfaces 332a and 352a, respectively (FIGS. 4A and 4B).

According to this configuration, only one of end surfaces 50a and 50b in the left-right direction of the protruding portion 52 of the guide member 50 abuts on the end surfaces 331a, 332a, 351a, and 352a of the protruding portions 331, 332, 351, and 352 of the power generation cell 1 (separator 3), so that the frictional resistance between the power generation cell 1 and the guide member 50 at the time of stacking the power generation cell 1 is small. Therefore, the power generation cell 1 can be easily stacked without providing a coating layer on the guide member 50, and the fuel cell stack 100 can be configured at low cost. In addition, the upper protruding portions 331 and 351 and the lower protruding portions 332 and 352 of the power generation cell 1 abut on the guide member 50 at the end surfaces 331a and 332a and the end surfaces 351a and 352a in different directions (different sides) in the left-right direction. Therefore, the power generation cell 1 can be stacked while being positioned in the case.

(2) The protruding portions 331 and 351 and the protruding portions 332 and 352 are provided symmetrically with respect to the center point P located at the center of the power generation cell 1 when the power generation cell 1 is viewed from the stacking direction, that is, in a plan view of the power generation cell 1 (FIGS. 4A and 4B). Accordingly, the positioning portions PT21 and PT 31 on the upper side surface 101 of the power generation cell 1 and the positioning portions PT22 and PT32 on the lower side surface 102 of the power generation cell 1 are symmetrically provided, so that the power generation cell 1 can be favorably positioned.

(3) The case 30 has a plurality of inner wall surfaces facing the upper side surface 101, the lower side surface 102, the left side surface 103, and the right side surface 104 of the power generation cell 1 (FIGS. 4A and 4B). The guide member 50 is provided on each of the plurality of inner wall surfaces, and the positioning portions PT11 to PT14, PT21 to PT24, and PT31 to PT34 are provided on the upper side surface 101, the lower side surface 102, the left side surface 103, and the right side surface 104 of the power generation cell 1, respectively. As a result, the power generation cell 1 can accurately be positioned in the left-right direction and the up-down direction.

(4) The separator 3 includes the first separator 31 disposed to face the front surface 2a (a first surface) of the UEA 2 and the second separator 32 disposed to face the rear surface 2b (a second surface) of the UEA 2 (FIG. 1). The protruding portion (a first protruding portion) 331 and the protruding portion (a second protruding portion) 332 of the first separator 31 are provided so as to be located on the left side (a first side) of the upper guide member 50 and on the right side (a second side) of the lower guide member 50, respectively (FIG. 4A). The protruding portion (a first protruding portion) 351 and the protruding portion (a second protruding portion) 352 of the second separator 32 are provided so as to be located on the right side (a second side) of the upper guide member 50 and on the left side (a first side) of the lower guide member 50, respectively (FIG. 4B). As a result, the guide member 50 is sandwiched between the protruding portions 331 and 332 of the first separator 31 and the protruding portions 351 and 352 of the second separator 32, so that the pair of separators 31 and 32 can be firmly positioned and held via the guide member 50.

(5) Each of the power generation cells 1 constitutes an edge, and has four sides located opposite to each other, that is, the upper side surface 101 and the lower side surface 102 opposite to the upper side surface 101, and the left side surface 103 and the right side surface 104 opposite to the left side surface 103 (FIGS. 4A and 4B). The protruding portions (a first protruding portions) 331 and 351 and the protruding portions (a second protruding portions) 332 and 352 are provided on the upper side surface 101 and the lower side surface 102, respectively (FIGS. 4A and 4B). As a result, the protruding portions 331 and 351 and the protruding portions 332 and 352 are provided on the upper side surface 101 and the lower side surface 102 opposite to each other, so that the power generation cell 1 can be favorably positioned in the left-right direction.

(6) In the power generation cell 1, the through-holes 211 to 216, 311 to 316 through which a gas and a cooling medium flow are provided near the left side surface 103 and the right side surface 104 (FIGS. 3, 4A, and 4B). The positioning portions PT23, PT24, PT33, and PT34 have the recessed portions (a first recessed portions) 341 and 361 and the recessed portions (a second recessed portions) 342 and 362 provided on the left side surface 103 and the right side surface 104, respectively (FIGS. 4A and 4B). The guide member 50 further includes the left guide member 50 that is inserted inside the recessed portions 341 and 361 and has the end surfaces 50a and 50b that abut on the upper end surface 341a of the recessed portion 341 and the lower end surface 361b of the recessed portion 361, respectively, and the right guide member 50 that is inserted inside the recessed portions 342 and 362 and has the end surfaces 50a and 50b that abut on the lower end surface 342b of the recessed portion 342 and the upper end surface 362a of the recessed portion 362, respectively (FIGS. 4A and 4B). Consequently, the recessed portions 341 and 361 and the recessed portions 342 and 362 are provided on the left side surface 103 and the right side surface 104 opposite to each other, so that power generation cell 1 can be favorably positioned also in the up-down direction. On the left side surface 103 and the right side surface 104, not the protruding portion but the recessed portions 341, 361, 342, and 362 are provided as the positioning portions PT23, PT24, PT33, and PT34, so that it is possible to prevent the power generation cell 1 from being enlarged in the left-right direction.

(7) The recessed portions 341 and 361 and the recessed portions 342 and 362 are provided symmetrically with respect to the center point P located at the center of the power generation cell 1 when the power generation cell 1 is viewed from the stacking direction, that is, in the plan view of the power generation cell (FIGS. 4A and 4B). Accordingly, the positioning portions PT23 and PT33 on the left side surface 103 of the power generation cell 1 and the positioning portions PT24 and PT34 on the right side surface 104 of the power generation cell 1 are symmetrically provided, so that the power generation cell 1 can be favorably positioned.

(8) The UEA 2 includes the MEA 20 including the electrolyte membrane 23, the anode electrode 24, and the cathode electrode 25, and the frame 21 provided with the opening 21a in which the MEA 20 is disposed (FIG. 3). The protruding portions 331, 332, 351, and 352 are provided on the upper side surface 101 and the lower side surface 102 of the separator 3 (FIGS. 4A and 4B). The frame 21 has the recessed portions 271 to 274 with which the guide member 50 engages on the upper side surface 101, the lower side surface 102, the left side surface 103, and the right side surface 104 (FIG. 3). As a result, it is possible to favorably position the UEA 2 with respect to the case 30 and to configure the cell stacked body 10. Since the frame 21 as a frame member has lower rigidity than the separator 3 and is easily deformed, the guide member 50 can be easily engaged with the recessed portions 271 to 274 when the power generation cell 1 is stacked.

(9) The size of the frame 21 in a plane perpendicular to the stacking direction (a length in the left-right direction and a length in the up-down direction), that is, in the plan view, is larger than the size of the separator 3 (a length in the left-right direction and a length in the up-down direction). Accordingly, since the frame 21 is interposed between the protruding portions 331 and 332 of the first separator 31 and the protruding portions 351 and 352 of the second separator 32, sufficient insulation between the first separator 31 and the second separator 32 can be secured.

The above embodiment can be modified in various forms. Below, some modified examples are described. In the above embodiment, the cell stacked body 10 is surrounded by a substantially rectangular parallelepiped case 30, but the configuration of a case is not limited to that described above. In the above embodiment, the guide member 50, which is a separate member from the case 30, is provided as a guide part protruding from the inner wall of the case 30 toward the cell stacked body 10, but the guide part may be formed on the inner wall of the case 30. In the above embodiment, the first protruding portions 331 and 351 and the second protruding portions 332 and 352 are provided on the upper side surface 101 (a first edge portion) and the lower side surface 102 (a second edge portion) of the power generation cell 1, respectively, but these protruding portions may be provided on the left side surface 103 and the right side surface 104.

In the above embodiment, the end surfaces 50a and 50b (a first abutting surface) of the upper guide member 50 (a first guide part) abut the end surfaces 331a and 351a (a first end surface) of the upper protruding portions 331 and 351 of the power generation cell 1, and the end surfaces 50a and 50b (a second abutting surface) of the lower guide member 50 (a second guide part) abut the end surfaces 332a and 352a (a second end surface) of the lower protruding portions 332 and 352 of the power generation cell 1. Additionally, the end surfaces 50a and 50b (a third abutting surface) of the left guide member 50 (a third guide part) abut the end surfaces 341a and 361b (a third end surface) of the left recessed portions 341 and 361 (a first recessed portion) of the power generation cell 1, and the end surfaces 50a and 50b (a fourth abutting surface) of the right guide member 50 (a fourth guide part) abut the end surfaces 342b and 362a (a fourth end surface) of the right recessed portions 342 and 362 (a second recessed portion) of the power generation cell 1. Further, the first and second end surfaces are provided on one side (a first side) in the left-right direction (a first direction) of the protruding portions 331 and 351 and on the other side (a second side) in the left-right direction of the protruding portions 332 and 352, and the third and fourth end surfaces are provided on one side (a third side) in the up-down direction (a second direction) of the recessed portions 341 and 361 and on the other side (a fourth side) in the up-down direction of the recessed portions 342 and 362. However, as long as there are first and second protruding portions having first and second end surfaces facing opposite sides to each other on at least the first edge portion and the second edge portion on the opposite side of the first edge portion, the configuration of a power generation cell can be any. The recessed portions 341 and 361 on the third side surface and the recessed portions 342 and 362 on the fourth side surface may be omitted. Protruding portions may be provided on the third and fourth side surfaces in the same manner as on the first and second end surfaces.

The above embodiment can be combined as desired with one or more of the above modifications. The modifications can also be combined with one another.

According to the present invention, it is possible to stack power generation cells while positioning them without providing a coating layer on a guide member, thereby enabling the configuration of a fuel cell stack at a low cost.

Above, while the present invention has been described with reference to the preferred embodiments thereof, it will be understood, by those skilled in the art, that various changes and modifications may be made thereto without departing from the scope of the appended claims.

What is claimed is:

1. A fuel cell stack comprising:
a power generation cell including a unitized electrode assembly having an electrolyte membrane and an electrode, and a separator;
a cell stacked body including a plurality of the power generation cells stacked in a predetermined direction;
a case surrounding the cell stacked body;
a guide part provided on an inner wall of the case and configured to protrude toward the cell stacked body and extend in the predetermined direction; and
a positioning portion provided on an edge portion of the power generation cell, corresponding to the guide part, to position the power generation cell relative to the case, wherein
the edge portion of the power generation cell includes a first edge portion and a second edge portion on an opposite side of the first edge portion,
the positioning portion includes a first protruding portion protruding from the first edge portion toward the inner wall and a second protruding portion protruding from the second edge portion toward the inner wall,
the first protruding portion and the second protruding portion includes a first end surface and a second end surface extending substantially perpendicular to the first edge portion and the second edge portion, respectively, when mutually opposite sides in a plan view perpendicular to the predetermined direction are defined as a first side and a second side, the first end surface is located on the first side and the second end surface is located on the second side, and
the guide part includes a first guide part having a first abutting surface provided so as to face the first end surface to abut the first end surface, and a second guide part having a second abutting surface provided so as to face the second end surface to abut the second end surface.

2. The fuel cell stack according to claim 1, wherein
the first protruding portion and the second protruding portion are provided symmetrically with respect to a central point of the power generation cell, the central point being located at a center of the power generation cell in the plan view.

3. The fuel cell stack according to claim 1, wherein
the case includes a plurality of inner walls facing a plurality of edge portions of the power generation cell,
the guide part is provided on each of the plurality of inner walls, and
the positioning portion is provided on each of the plurality of edge portions.

4. The fuel cell stack according to claim 1, wherein
the separator includes a first separator disposed to face a first surface of the unitized electrode assembly, and a second separator disposed to face a second surface of the unitized electrode assembly, the second surface being on an opposite side of the first surface in the predetermined direction,
each of the first separator and the second separator includes the first protruding portion and the second protruding portion,
the first protruding portion and the second protruding portion of the first separator is located on the first side of the first guide part and the second side of the second guide part, respectively, and
the first protruding portion and the second protruding portion of the second separator is located on the second side of the first guide part and the first side of the second guide part, respectively.

5. The fuel cell stack according to claim 1, wherein
the power generation cell includes the first edge portion and the second edge portion extending along in a first direction in the plan view, and a third edge portion and a fourth edge portion on an opposite side of the third edge portion, the third edge portion and the fourth edge portion extending along in a second direction perpendicular to the first direction in the plan view.

6. The fuel cell stack according to claim 5, wherein
through holes through which a gas and a cooling medium flow are provided near each of the third edge portion and the fourth edge portion of the power generation cell,
the positioning portion further includes a first recessed portion provided on the third edge portion and a second recessed portion provided on the fourth edge portion,
the first recessed portion and the second recessed portion include a third side surface and a fourth side surface extending substantially perpendicular to the third edge portion and the fourth edge portion, respectively,
when mutually opposite sides in the second direction in the plan view are defined as a third side and a fourth side, the third side surface is located on the third side and the fourth side surface is located on the fourth side,
the guide part further includes a third guide part disposed in the first recessed portion and a fourth guide part disposed in the second recessed portion, and
the third guide part and the fourth guide part have a third abutting surface to abut the third side surface and a fourth abutting surface to abut the fourth side surface, respectively.

7. The fuel cell stack according to claim 6, wherein
the first recessed portion and the second recessed portion are provided symmetrically with respect to a central point of the power generation cell, the central point being located at a center of the power generation cell in the plan view.

8. The fuel cell stack according to claim 1, wherein
the unitized electrode assembly includes a membrane electrode assembly having the electrolyte membrane and the electrode, and a frame member in which an opening is formed,
the membrane electrode assembly is disposed to cover the opening,
the first protruding portion and the second protruding portion are provided on edge portions of the separator, and
the frame member includes recessed portions provided at edges of the frame member to engage with the first guide part and the second guide part.

9. The fuel cell stack according to claim 8, wherein
a size of the frame member in the plan view is larger than a size of the separator.

10. The fuel cell stack according to claim 1, wherein
each of the first edge portion and the second edge portion includes a recessed portion,
the first protruding portion is protruded from a bottom surface of the recessed portion of the first edge portion toward the inner wall, and
the second protruding portion is protruded from a bottom surface of the recessed portion of the second edge portion toward the inner wall.
